(19) United States
(12) Patent Application Publication
(10) Pub. No.: US 2021/0310907 A1
(43) Pub. Date: Oct. 7, 2021

(54) TAMPER RESISTANT SPORE TRAP

(71) Applicant: Ultimo Global Holdings, LLC, Wilmington, DE (US)

(72) Inventor: Phillip Nathan Thornberry, Carmel, IN (US)

(73) Assignee: Ultimo Global Holdings, LLC, Wilmington, DE (US)

(21) Appl. No.: 16/840,696

(22) Filed: Apr. 6, 2020

(51) Int. Cl. G01N 1/22

(52) U.S. Cl. CPC G01N 1/2226; G01N 2001/028

(57) ABSTRACT

In certain aspects, the present disclosure provides unique devices and methods for detecting mold spores in a target environment. In accordance with some forms of the disclosure, such devices are configured to provide tamper resistant spore trap cassettes.

### BACKGROUND

Environmental testing is an increasingly important aspect of evaluation of a structure. Mold or other unseen contaminants may escape the observation of an inspector. In general, mold may be detected by utilizing a spore trap sampler. Spore trap samplers function by pulling air through a sample slit, which accelerates the particles in the air stream. A small glass slide that is covered with an adhesive sampling media is positioned in the path of the air stream. The device is configured such that at optimal airflow rates mold spore particles will contact and adhere to the adhesive surface, while smaller particles move with the airflow around the glass slide. Prior spore trap cassettes were often sealed with a sticker and could be easily opened allowing access to the sample resulting in contamination of the sample prior to testing. Thus, there is a need for improvement in this field.

### SUMMARY

In certain aspects, the present disclosure provides unique devices and methods for detecting mold spores in a target environment. In accordance with some forms of the disclosure, such devices are configured to provide a tamper resistant mold spore cassette. Thus, in certain embodiments the present disclosure provides a tamper resistant spore trap cassette, comprising an inlet housing defining an inlet opening, and an outlet housing defining an outlet opening, wherein said outlet housing is configured to receive said inlet housing, and wherein said inlet housing mechanically locks into the outlet housing. In accordance with some forms, a sample collection enclosure is defined by an interior surface of the inlet housing and an interior surface of the outlet housing. In certain embodiments, a sample collection slide is contained within the sample collection enclosure. In some forms, the outlet opening is adapted for connection to a means for drawing air through the cassette. In addition, the outlet housing may comprise a cavity, configured to receive at least a portion of the inlet housing. In some forms, the insertable portion of the inlet housing has a diameter equal to or greater than a diameter of the cavity of the outlet housing such that upon insertion the outlet housing and the inlet housing are joined together by a friction fitting.

In accordance with some forms, the tamper resistant spore trap cassette of the present disclosure may include a locking member configured to secure the insertable portion within the cavity. In some forms, the locking member comprises two or more interlocking ridge members disposed on the insertable portions and the cavity.

Other embodiments of the present disclosure provide a tamper resistant spore trap cassette, comprising an inlet housing defining an inlet opening, an outlet housing defining an outlet opening, wherein the outlet housing is configured to receive the inlet housing such that an airway is defined from the inlet opening to the outlet opening, and wherein the inlet housing mechanically locks into the outlet housing, and a sample collection slide positioned within the cassette and in the path of the airway. In accordance with some forms, a sample collection enclosure is defined by an interior surface of the inlet housing and an interior surface of the outlet housing, and the sample collection slide is contained within the sample collection enclosure. In some forms, the outlet opening is adapted for connection to a means for drawing air through the cassette. In addition, the outlet housing may comprise a cavity, configured to receive at least a portion of the inlet housing. In some forms, the insertable portion of the inlet housing has a diameter equal to or greater than a diameter of the cavity of the outlet housing such that upon insertion the outlet housing and the inlet housing are joined together by a friction fitting.

In accordance with some forms, the tamper resistant spore trap cassette of the present disclosure may include a locking member configured to secure the insertable portion within the cavity. In some forms, the locking member comprises two or more interlocking ridge members disposed on the insertable portions and the cavity.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a front perspective view of one embodiment of a tamper resistant spore trap of the present disclosure.

FIG. 2 is a rear perspective view of one embodiment of a tamper resistant spore trap of the present disclosure.

FIG. 3 is a front view of one embodiment of a tamper resistant spore trap of the present disclosure.

FIG. 4 is a rear view of one embodiment of a tamper resistant spore trap of the present disclosure.

FIG. 5 is a side view of one embodiment of a tamper resistant spore trap of the present disclosure.

FIG. 6 is a cross-sectional view of one embodiment of a tamper resistant spore trap of the present disclosure.

FIG. 7 is a cross-sectional view of one embodiment of an outlet housing of the present disclosure.

FIG. 8 is a cross-sectional view of one embodiment of an inlet housing of the present disclosure.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

The present disclosure provides for tamper resistant spore trap cassettes and methods of using same. The spore trap cassettes of the present disclosure comprise an inlet housing and an outlet housing, which fit together to provide a sample collection enclosure in which air samples are obtained. In certain embodiments, a sample collection slide may be positioned within the sample collection enclosure and positioned such that airflow passing through the cassette contacts the sample collection slide.

In some forms, the inlet housing of the tamper resistant sport trap cassette has an inlet opening. The inlet opening may be generally square or rectangular in nature having internal walls that taper into a corresponding narrow slot defining an inner inlet opening. In this way, the inlet opening may be configured such that a volume of air is rapidly accelerated to a significantly high velocity. The tapered walls may be configured to form an angle selected to optimize airspeed through the cassette. In some forms, the tapered walls form an angle of 1° to 60°, preferably the tapered walls form an angle of 15° to 45°, even more preferably the tapered walls form an angle of 30° to 40°. In accordance with some forms, the tapered walls form an angle of about 36° Thus the system is configured such that the high velocity air carries any particulate materials, such as mold spores, with it, which are also subject to acceleration and increased velocity.

In some forms, a sample collection slide is present within the sample collection enclosure and in front of the inner inlet opening in order to obstruct the direct path of the accelerated air and particle flow. In certain embodiments, a sample collection slide may be held in place by the inlet housing and/or the outlet housing. In some forms, the inlet housing and/or the outlet housing may comprise one or more positioning arms configured to secure the sample collection slide within the sample collection enclosure and in position to obstruct airflow. Thus, a collection area of the sample collection slide is defined in front of the inner inlet opening. In certain embodiments, the collection area comprises a portion of the sample collection slide. The sample plate may not fully enclose the sample collection enclosure, but a gap or other space at one or more edges of the of the sample collection slide may be present between the slide and the sidewalls of the inlet housing and/or outlet housing to allow the escape of air and any particles not collected by the adhesive medium present on the surface of the sample collection slide.

In certain embodiments, the tamper resistant spore trap of the present disclosure is configured such that after contacting the sample collection slide the accelerated air travels around the slide and onto the interior of the outlet housing where an outlet opening (e.g. a nozzle or other outlet configuration) is subject to vacuum pressure which pulls the air through the cassette and the tapered top inlets of the inlet housing.

In accordance with some variants, the inlet housing and the outlet housing are configured to attach to one another forming the disclosed spore trap cassette. In certain embodiments, the outlet housing has a well, reservoir, or other receiving area for the inlet housing. In accordance with certain preferred embodiments the inlet housing has a first portion and a second portion, and wherein the second portion has a diameter less than that of the first portion, such that the second portion of the inlet housing is configured to fit within a receiving area of the outlet housing. In certain embodiments, the first portion of the inlet housing has an outer diameter, which is generally equivalent to an outer diameter of the outlet housing. In some forms, the inlet housing has an inner surface, and the outlet housing has an inner surface, such that when brought together the inner surfaces form an enclosed area. Thus, air passing through the device travels into the inlet opening, through and about the enclosed area defined between the inlet housing and the outlet housing and out of the outlet opening.

In certain embodiments, the outlet housing is configured to receive the inlet housing. In certain embodiments, the outlet housing comprises a receiving area and the inlet housing comprises an insertable portion configured to fit within the receiving area. In some forms the receiving area has an internal diameter and the insertable portion has an exterior diameter configures to fit within the receiving area. It is within the scope of the disclosure to provide a device wherein the inlet housing is configured to receive the outlet housing. Such a device is similar to those illustrated in the figures herein, however the inlet housing comprises a receiving area and the outlet housing comprises an insertable portion configured to fit within the receiving area. Certain embodiments include an inlet housing having a receiving area having an inner diameter, and the outlet housing includes at least a portion having an external diameter configured to fit within the receiving area.

In some forms, the present disclosure provides for tamper resistant spore trap cassettes wherein the inlet housing and the outlet housing lock together. Such inventive contracts advantageously prevent sample contamination and provide a more reliable test. The inlet and outlet housings may lock together in any suitable way, ensuring that the enclosed sample collection media cannot easily accessible. In some forms, the inlet housing and the outlet housing mechanically lock together. As described herein the term “mechanically lock” refers to some feature of the housing units themselves, which forms the locking relationship without the need of additional securement, such as an adhesive sticker. The mechanical lock may include, for example, press fit, force fit, shrink fit, interference fit, pin(s), spline(s), hoop(s), ridge(s), anchor(s), rib(s), teeth, or any other suitable locking mechanism. In some forms, the inlet housing and/or the outlet housing may be heated and/or cooled before or during assembly to expand/contract the material or to render the material more pliable.

In accordance with some forms, the inlet housing and/or outlet housing may comprise one or more locking members, such as a barb or spline. Such features may be present on the interior surface of the receiving member, and/or on the exterior surface of the insertable member. In other embodiments, such as when the device is configured for a press fit engagement, the inner member (e.g. the second portion of the inlet housing) has an outer surface, which presses against an inner surface of the outer member (e.g. the outlet housing).

Accordingly, the inlet and outlet housings of the tamper resistant spore traps disclosed herein such that the sample collection slide cannot be accessed without use of a tool, such as a pry bar, wedge, or other implement.

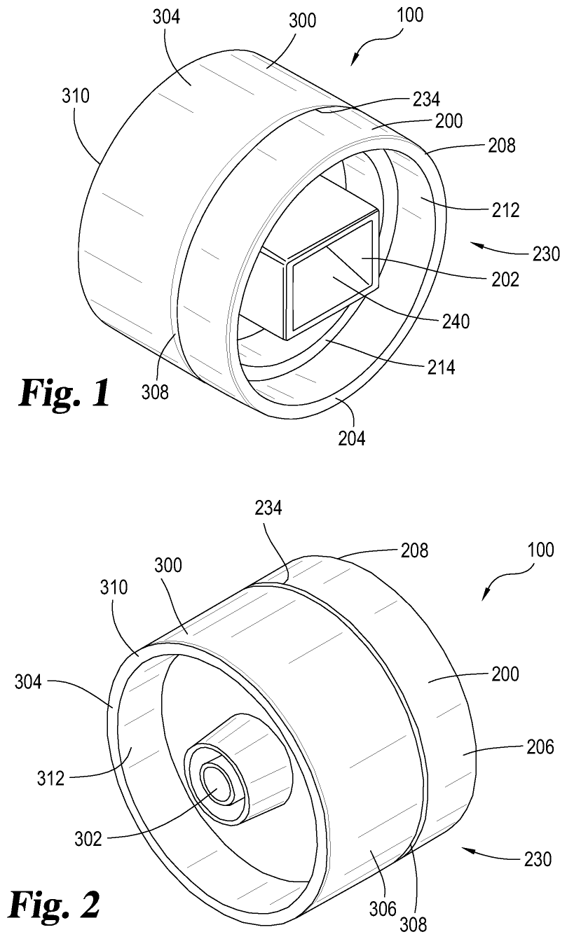

With reference to FIG. 1, shown is a front perspective view of one embodiment of a tamper resistant spore trap of the present disclosure. In the illustrated embodiment, spore trap cassette 100 comprises inlet housing 200 and outlet housing 300. Inlet outer wall 204, having an outer surface 206 and an inner surface 212, is generally cylindrical, although other shapes are envisioned. In the illustrated embodiment, inlet-opening 202 is generally rectangular, and comprises opposing tapered wall portions 240. In the illustrated embodiment, the first portion 230 of the inlet housing extends from proximal end 208 to outer ridge 234. In certain embodiments, the outer ridge of the inlet housing is a transition from the first portion to the second portion, the second portion having a smaller diameter and insertable into the opposing housing. Thus, the outer ridge may be generally perpendicular to the outer wall of the first portion and/or the second portion. In some forms, the outlet outer wall 304 contacts the outer ridge of the inlet housing. In the illustrated embodiment, the outlet outer wall is generally cylindrical, although other configurations are envisioned. In the illustrated embodiment, the outer outlet wall has an outer surface 306, and extends from outer housing distal end 310 to outlet housing proximal end 308.

Turning now to figure two, shown is a rear perspective view of one embodiment of a tamper resistant spore trap of the present disclosure. In the illustrated embodiment, spore trap cassette 100 comprises inlet housing 200 and outlet housing 300. Outlet outer wall 304, having an outer surface 306 and an inner surface 312, is generally cylindrical, although other shapes are envisioned. In the illustrated embodiment, outlet opening 302 is adapted for connection to a means for drawing air through the cassette, such as to a vacuum tube or fan assembly. In the illustrated embodiment, the outer outlet wall outer surface extends from outer housing distal end 310 to outlet housing proximal end 308. In the illustrated embodiment, the first portion 230 of the inlet housing has an outer surface 206, which extends from proximal end 208 to outer ridge 234.

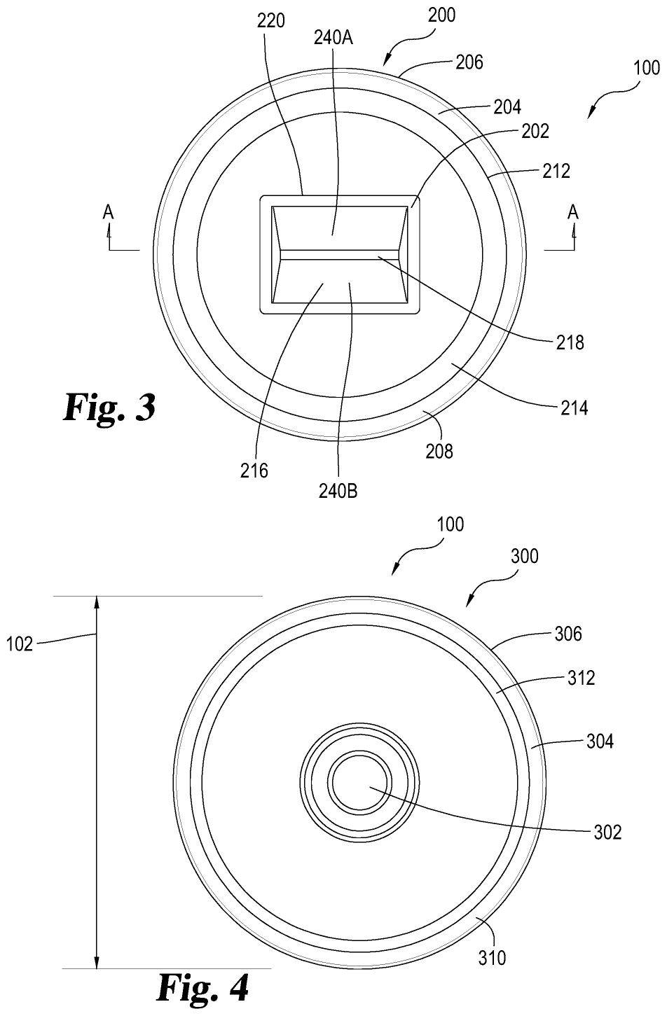

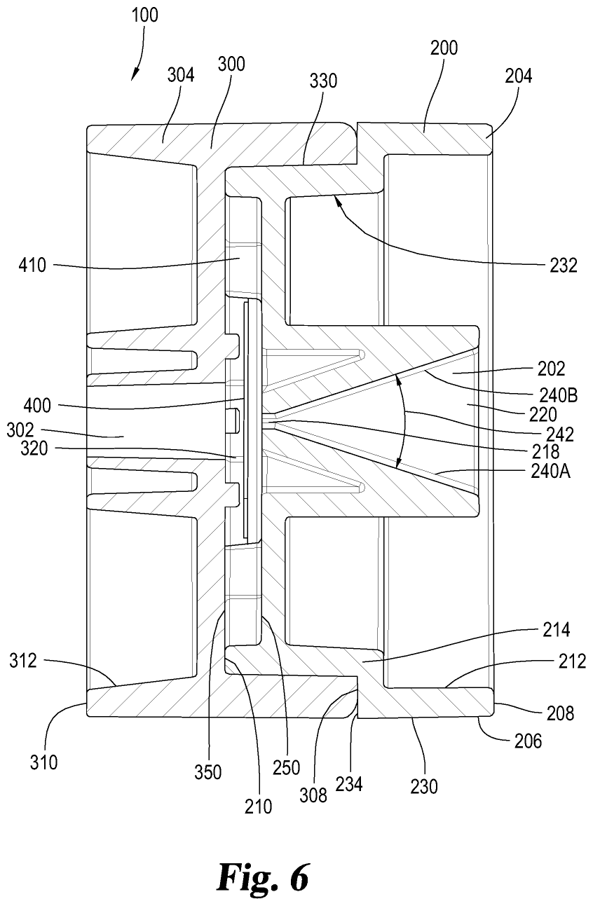

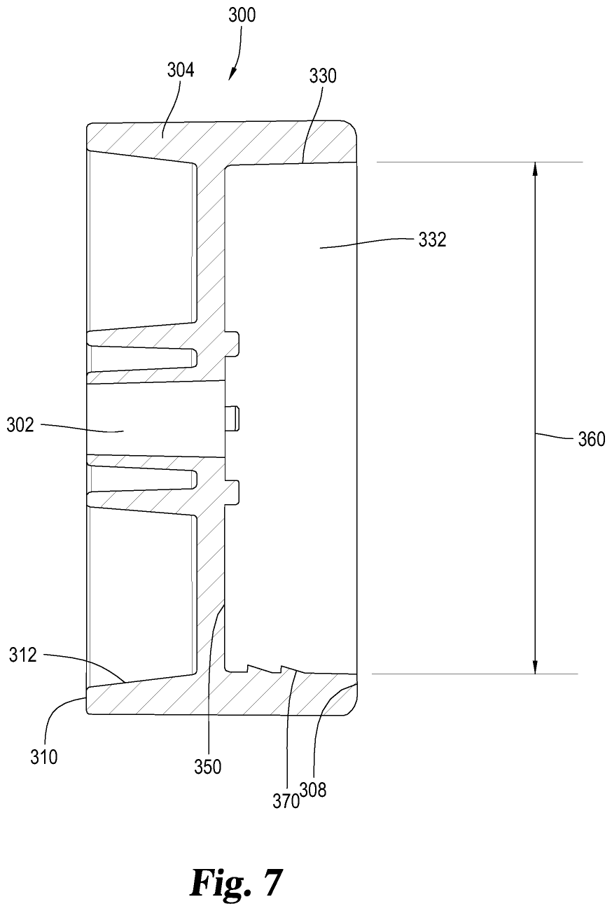

FIG. 3 is a front view of one embodiment of a tamper resistant spore trap 100 of the present disclosure. More specifically FIG. 3 shows a front view of one embodiment of an inlet housing 200. Inlet outer wall 204, having an outer surface 206 and an inner surface 212, is generally cylindrical, although other shapes are envisioned. In the illustrated embodiment, inlet-opening 202 is generally rectangular, and comprises inlet funnel 216. Inlet funnel 216 comprises opposing tapered wall portions 240A and 240B. The inlet opening extends from outer inlet opening 220 to inner inlet opening 218. As disclosed above, in some forms the inlet housing may comprise an inner ridge 214, and proximal inlet end 208. Cross Section A through the inlet and outlet fittings is shown in detail at FIGS. 6-7.

FIG. 4 is a rear view of one embodiment of a tamper resistant spore trap 100 of the present disclosure. The illustrated spore trap has an outer diameter 102. As discussed herein the maximum outer diameter of the inlet and/or outlet housing components may be roughly equivalent. More specifically FIG. 4 shows a rear view of one embodiment of an outlet housing 300. Outlet outer wall 304, having outer surface 306 and inner surface 312, is generally cylindrical, although other shapes are envisioned. In the illustrated embodiment, outlet-opening 302 is adapted for connection to a means for drawing air through the cassette as discussed herein.

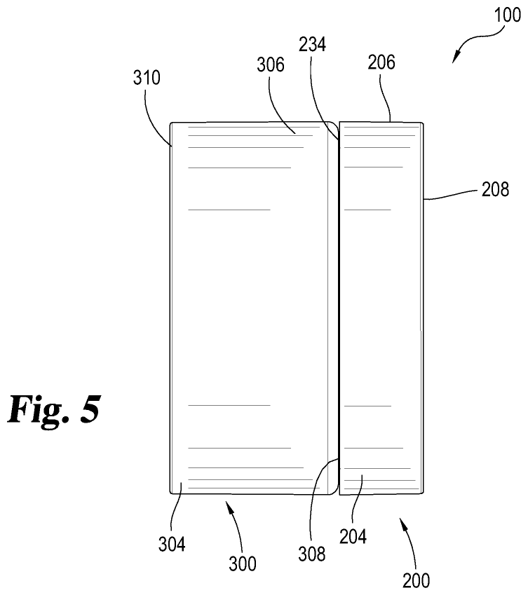

With reference to FIG. 5, provided is a side view of one embodiment of a tamper resistant spore trap of the present disclosure. In the illustrated embodiment, spore trap cassette 100 comprises inlet housing 200 and outlet housing 300. A first portion 230 of the inlet housing is visible with outer wall 204, having an outer surface 206 extending from proximal end 208 to ridge 234. In the illustrated embodiment, outlet housing outer wall 304 has an outer wall surface 306 extending from distal end 310 to proximal end 308.

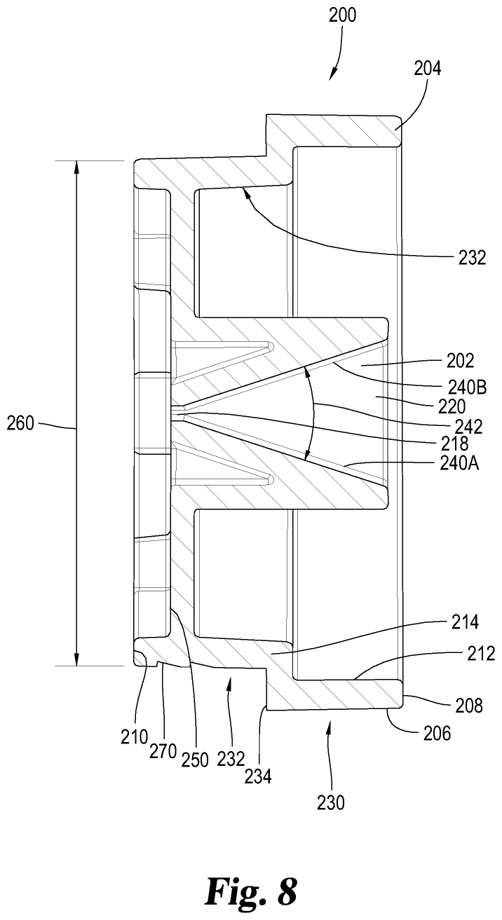

Turning now to FIGS. 6-8, shown is a cross-sectional view of one embodiment of a tamper resistant spore trap of the present disclosure, showing cross-section A of FIG. 3. FIG. 6 illustrates one embodiment of an assembled tamper resistant spore trap cassette 100 comprising outlet portion 300 and inlet portion 200. FIG. 7 illustrates one embodiment of outlet housing 300. FIG. 8 illustrates one embodiment of inlet housing 200.

The illustrated embodiments (FIGS. 6 and 8) include inlet outer wall 204 having outer surface 206 and an inner surface 212, and a first portion 230 and second portion 232. In the illustrated embodiment, the first portion 230 of the inlet housing extends from proximal end 208 to outer ridge 234. In the illustrated embodiment, inlet opening 202 extends from outer inlet opening 220 to inner inlet opening 218, and comprises opposing tapered wall portions 240A and 240B. As discussed herein, tapered wall portions form inlet angle 242. The inlet housing extends from proximal inlet end 208 to distal inlet end 210. As disclosed herein, in certain embodiments, the inlet housing comprises a first portion having approximately the same outer diameter as the outlet housing, and a second portion with a smaller outer diameter sized to fit within the a portion of the outlet housing configured to receive the inlet housing. Thus, first portion has a diameter 102 that is greater than the second person diameter 260. In the illustrated embodiment, outer ridge 234 and inner ridge 214 extends generally perpendicular to first portion 230 and second portion 232. In some forms, the inlet housing may comprise one or more locking members 270 configured to secure the inlet housing to the outlet housing.

The illustrated embodiments (FIGS. 7 and 8) include outlet outer wall 304 extending from outlet proximal end 308 to outlet distal end 310, and having outlet outer surface 306 and outlet inner surface 312. In the illustrated embodiment, the outlet proximal end contacts the outer ridge of the inlet member. The outlet housing further defines outlet-opening 302.

In accordance with some forms, a sample collection enclosure 410 is formed between inner surface 250 of the inlet housing and inner surface 350 of the outlet housing. In certain embodiments, a sample collection slide 400 is received within the sample collection enclosure. In some forms, one or more positioning arms 320 extend from the inner surface of the outlet housing and/or inlet housing to position and support the sample collection slide. With particular reference to FIG. 7, the outlet housing is configured to receive at least a portion of the inlet housing. For example, receiving area 332 has an inner diameter 360 configured to receive the second portion of the inlet housing. In some forms the inner diameter of the receiving area is approximately equivalent to or slightly smaller than the diameter of the second portion of the inlet housing so as to cause a press fight lock when assembled. In other embodiments the outlet housing may comprise one or more locking members 370 configured to secure the outlet housing to the inlet housing. Thus in some forms, for example when a locking member is present, the diameter of the receiving area may be greater than the diameter of the inlet housing second portion.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A tamper resistant spore trap cassette, comprising:
an inlet housing defining an inlet opening; and
an outlet housing defining an outlet opening, wherein said outlet housing is configured to receive said inlet housing, and wherein said inlet housing mechanically locks into said outlet housing.

2. The tamper resistant spore trap cassette of claim 1, comprising:
a sample collection enclosure defined by an interior surface of said inlet housing and an interior surface of said outlet housing.

3. The tamper resistant spore trap cassette of claim 2, comprising:
a sample collection slide within said sample collection enclosure.

4. The tamper resistant spore trap cassette of claim 1, wherein said outlet opening is air adapted for connection to a means for drawing through the cassette.

5. The tamper resistant spore trap cassette of claim 1, wherein said outlet housing comprises a cavity, and wherein said inlet housing comprises an insertable portion configured to fit within said cavity of said outlet housing.

6. The tamper resistant spore trap cassette of claim 5, wherein said insertable portion of said inlet housing has a diameter equal to or greater than an internal diameter of said cavity of said outlet housing.

7. The tamper resistant spore trap cassette of claim 5, further comprising a locking member configured to secure said insertable portion within said cavity.

8. The tamper resistant spore trap cassette of claim 7, wherein said locking member comprises two or more interlocking ridge members disposed on said insertable portion and said cavity.

9. A tamper resistant spore trap cassette, comprising:
an inlet housing defining an inlet opening;
an outlet housing defining an outlet opening, wherein said outlet housing is configured to receive said inlet housing such that an airway is defined from said inlet opening to said outlet opening, and wherein said inlet housing mechanically locks into said outlet housing; and
a sample collection slide positioned within the cassette and exposed to said airway.

10. The tamper resistant spore trap cassette of claim 9, comprising:
a sample collection enclosure defined by an interior surface of said inlet housing and an interior surface of said outlet housing, wherein said sample collection slide is positioned within said sample collection enclosure.

11. The tamper resistant spore trap cassette of claim 9, wherein said outlet opening is adapted for connection to a means for drawing air through the cassette.

12. The tamper resistant spore trap cassette of claim 9, wherein said outlet housing comprises a cavity, and wherein said inlet housing comprises an insertable portion configured to fit within said cavity of said outlet housing.

13. The tamper resistant spore trap cassette of claim 12, wherein said insertable portion of said inlet housing has a diameter equal to or greater than a diameter of said cavity of said outlet housing such that upon insertion of said insertable portion into said cavity said outlet housing and said inlet housing are joined together by a friction fitting.

14. The tamper resistant spore trap cassette of claim 12, further comprising a locking member configured to secure said insertable portion within said cavity.

15. The tamper resistant spore trap cassette of claim 14, wherein said locking member comprises two or more interlocking ridge members disposed on said insertable portion and said cavity.
